(19) United States
(12) Patent Application Publication
(10) Pub. No.: US 2009/0141661 A1
(43) Pub. Date: Jun. 4, 2009

(54) RESIDUAL TRAFFIC STATE FOR WIRELESS NETWORKS

(75) Inventors: Zexian Li, Espoo (FI); Ravi Pandey, Masala (FI); Roman Pichna, Espoo (FI)

Correspondence Address: BRAKE HUGHES BELLERMANN LLP, c/o CPA Global, P.O. BOX 52050, MINNEAPOLIS, MN, 55402, US

(73) Assignees: Nokia Siemens Networks Oy, Espoo (FI); Nokia Corporation, Espoo (FI)

(21) Appl. No.: 11/947,748

(22) Filed: Nov. 29, 2007

(51) Int. Cl. G08C 17/00

(52) U.S. Cl. 370/311

(57) ABSTRACT

Various example embodiments are disclosed herein. In an example embodiment, an apparatus may include a controller, a memory coupled to the controller and a wireless transceiver coupled to the controller. The apparatus may be configured to detect a residual traffic pattern associated with a mobile station in a wireless network, and transition the mobile station from an active state to a residual traffic state based on the detecting. The transitioning may include sending a change uplink (UL) data service message to the mobile station to change the UL data service for the mobile station from a first UL service type to a second UL service type.

### TECHNICAL FIELD

This description relates to wireless networks.

### BACKGROUND

Mobile stations in wireless networks may sometimes transition to an idle state (or low power or sleep state) to conserve battery power during periods of inactivity. However, in some cases, even receiving or transmitting, e.g., only one or two packets every few minutes, or low data rate transmissions, may prevent the mobile station from entering into idle state or low power mode. In such a case, the battery power may be quickly reduced.

### SUMMARY

According to an example embodiment, a method may include detecting a residual traffic pattern associated with a mobile station in a wireless network, and transitioning the mobile station from an active state to a residual traffic state based on the detecting. The transitioning may include sending a change uplink (UL) data service message to the mobile station to change the UL data service for the mobile station from a first UL service type to a second UL service type.

In another example embodiment, an apparatus may include a controller, a memory coupled to the controller and a wireless transceiver coupled to the controller. The apparatus may be configured to detect a residual traffic pattern associated with a mobile station in a wireless network, and transition the mobile station from an active state to a residual traffic state based on the detecting. The transitioning may include sending a change uplink (UL) data service message to the mobile station to change the UL data service for the mobile station from a first UL service type to a second UL service type.

According to another example embodiment, a method may include detecting an active traffic pattern associated with a mobile station, and transitioning the mobile station from a residual traffic state to an active state based on the detecting the active traffic pattern. The transitioning may include sending a change uplink (UL) data service message to the mobile station to change the UL data service for the mobile station from a first UL service type to a second UL service type.

An apparatus may include a controller, a memory and a wireless transceiver. The apparatus may be configured to detect an active traffic pattern associated with a mobile station, transitioning the mobile station from a residual traffic state to an active state based on the detecting the active traffic pattern, including: sending a change uplink (UL) data service message to the mobile station to change the UL data service for the mobile station from a first UL service type to a second UL service type.

In another example embodiment, a method may include detecting, by a mobile station in a wireless network, a residual traffic pattern, sending, in response to the detecting, a state transition request from the mobile station to an infrastructure node to request a transition to a residual traffic state for the mobile station, receiving a message at the mobile station from the infrastructure node instructing the mobile station to enter a residual traffic state, and entering, by the mobile station, a residual traffic state.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a state diagram illustrating operating states for a mobile station according to an example embodiment.

FIG. 3 is a flow chart illustrating operation of a base station or other node according to an example embodiment.

FIG. 4 is a flow chart illustrating operation of a base station or other node according to another example embodiment.

FIG. 5 is a flow chart illustrating operation of a base station or other node according to yet another example embodiment.

FIG. 6 is a block diagram of a wireless node according to an example embodiment.

FIG. 7 is a flow chart illustrating operation of a wireless node according to an example embodiment.

### DETAILED DESCRIPTION

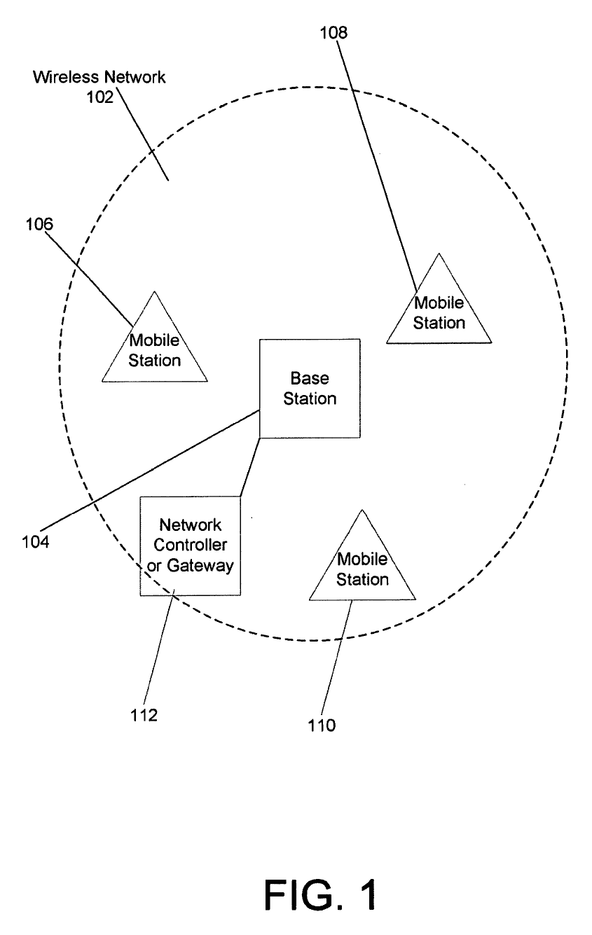

Referring to the Figures in which like numerals indicate like elements, FIG. 1 is a block diagram of a wireless network 102 including a base station (BS) 104 and mobile stations (MS) 106, 108, 110, according to an example embodiment. Each of the MSs 106, 108, 110 may be associated with BS 104, and may transmit data in an uplink direction to BS 104, and may receive data in a downlink direction from BS 104, for example. Although only one BS 104 and three mobile stations (MS 106, 108 and 110) are shown, any number of base stations and mobile stations may be provided in network 102. Also, although not shown, mobile stations 106, 108 and 110 may be coupled to base station 104 via relay stations or relay nodes, for example. A network controller or gateway 112 may be coupled to the base stations (e.g., BS 104) via wired or wireless links. In an example embodiment, network controller 112, if present, may provide control for one or more network tasks or functions, either for or in cooperation with one or more base stations in network 102. Although not shown, network controller 112 and base station 104 may each be connected to a wired network, such as a Local Area Network, a Wide Area Network (WAN), the Internet, etc.

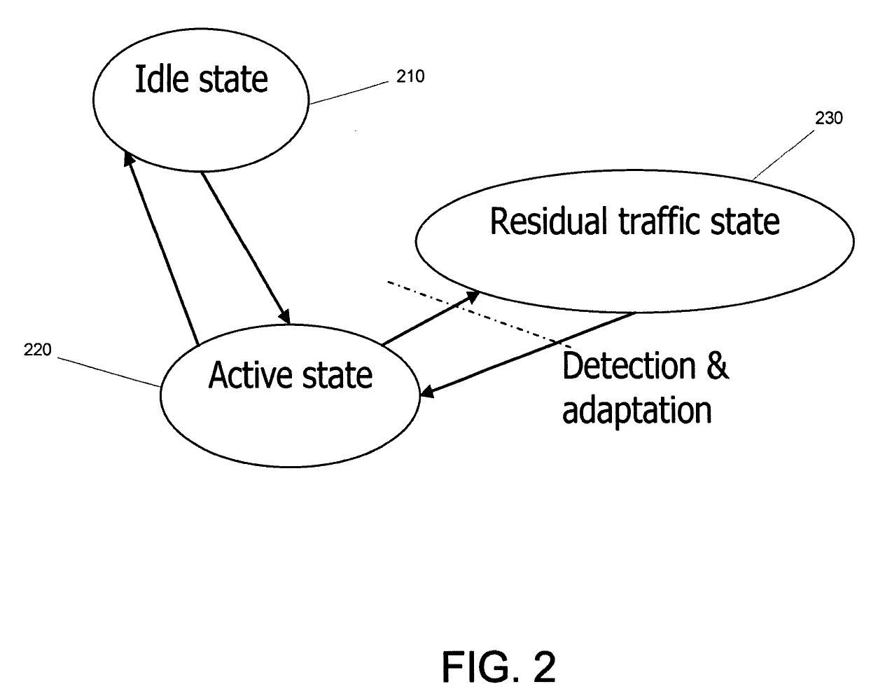

FIG. 2 is a state diagram illustrating operating states for a mobile station according to an example embodiment. A mobile station may typically operate in an active state (also known as a full power mode), where the MS can perform all of its basic functions. However, in order to save or conserve battery power, the MS may transition to an idle state (also known as low power mode or power save mode), where many hardware blocks in the MS may have power turned off. For example, the MS may periodically wake from idle state to receive a beacon to determine if there is data to be transmitted to it from a base station. If there is no data to be received by the MS, then the MS may go back to idle state to conserve power. If the beacon (e.g., from the BS) indicates that data will be transmitted to the MS in the next data frame, then the MS remains in active state to receive and process the data. This is merely an example, and other power save implementations may be used where the MS may transition to an idle state or power save mode.

However, in some cases, even a small amount of data (e.g., one or two packets) transmitted to or from the MS may in some cases prevent the MS from entering into idle state. For example, residual traffic transmitted to or from a MS may amount to a relatively small data rate or only a few packets, but may prevent the MS from entering into idle state. Residual traffic may include background activity of programs or applications and operating system activity, for example. For example, after all user applications (e.g., HTTP web browser, email program, Adobe Acrobat program, Word editor program) have been closed (or no longer used by the user) on a MS, the data that may continue to be transmitted by the MS to the BS may be considered to be residual traffic. This residual traffic may include, for example, network traffic generated by a network disk drive, an antivirus program that periodically checks the network for updates, an Acrobat or other program that periodically wakes up and checks for network updates, a program that periodically receives or requests and receives an updated time (e.g., from a universal clock), an operating system that periodically checks a network for OS updates, etc. The residual traffic may include, for example, either data transmitted from the MS and/or data received by the MS. In the case of received data, residual traffic may be either solicited (requested) or unsolicited.

Therefore, according to an example embodiment, a BS may detect a residual traffic pattern for a MS, and may transition (or change) the MS from active state 210 to a residual traffic state 230. For example, a residual traffic pattern may be a pattern of traffic associated with the MS (e.g., either to or from the MS) that is or appears to be at least primarily residual type traffic. For example, the BS may detect a residual traffic pattern for a MS based on an amount of traffic to or from the MS, where an amount of traffic to or from the MS that is below a threshold may indicate (primarily) residual traffic. For example, the BS may detect an amount of traffic transmitted by the MS to the BS and/or the amount of traffic transmitted by the BS (or stored in BS buffers waiting for transmission to the MS), and compare this amount of traffic over a period of time to a threshold. If the amount of traffic to and/or from the MS is less than a threshold, then this may be a residual traffic pattern.

In another example embodiment, the BS may detect a residual traffic pattern for the MS by detecting the types of traffic transmitted to or from the MS, and confirming that these detected types of traffic (either to or from the MS) are not associated with active user applications or active user activity (e.g., web browsing, sending email, file transfer). In this case, the BS may, for example, detect the type of traffic associated with each (or one or more) packets transmitted from or to the MS. For example, if only (or primarily) OS traffic (e.g., requesting or periodically checking for OS updates) is detected from the MS, then this may be an example residual traffic pattern. Other ways or techniques may be used to determine or detect a residual traffic pattern for a MS.

After a BS detects a residual traffic pattern for a MS, the BS may transition the MS from an active state to residual traffic state 203. In an example embodiment, transitioning the MS to a residual traffic state may include the BS buffering DL data directed to the MS until an amount of DL data for the MS reaches (or exceeds) a threshold, or until a timer expires. This may allow the MS to receive larger, but less frequent, DL transmissions from the BS. This may, at least in some cases, result in improved conservation of battery power for the MS, for example.

The BS transitioning the MS to a residual traffic state may also include changing the uplink (UL) data service (or MAC QoS) for the MS, e.g., to a data service that may be more power (or battery) efficient while still being able to handle a low data rate transmissions from the MS that may be associated with residual traffic. A BS may transition a MS to residual traffic state by the BS sending (or transmitting) a change uplink (UL) data service message to the MS to change the UL data service for the MS from a first UL data service (e.g., currently being used by the MS in active state) to a second UL data service type (which may be more power efficient than the first data service type).

In an example embodiment, UL data services may include data service types where the MS is required to solicit or request UL transmission resources, by polling or sending a request to the BS. These service types that involve a solicited resource grant from the BS may include IEEE 802.16 Best Effort, real time polling service (rtps), non real time polling service, and others. The 802.16 service types or scheduling types are merely used as examples, and the disclosure and claims are not limited thereto.

On the other hand, there are UL data service types that may involve unsolicited resource grants, which may be considered more power efficient (than the types that provide solicited resource grants), and thus may save battery power in some cases, since there is no need for the MS to poll or request the BS for UL data resources every time the MS would like to transmit data to the BS. Rather, these unsolicited resource grants may provide a grant every n frames, or provide a given UL bit rate, etc., which may be used for low rate residual UL traffic from the MS, for example. For example, an IEEE 802.16 unsolicited grant service (UGS) may provide unsolicited fixed size resource grants at periodic intervals (e.g., every n frames). Similarly, extended real time polling service (extended rtPS) may provide unsolicited dynamic size resource grants at periodic intervals, where the size of the resource grant may be adjusted (or at least a change requested) based on a resource (or bandwidth) change request message sent from the MS to the BS.

In addition, the BS may measure or determine the amount of residual traffic (or residual traffic load) associated with a MS, and may adjust or scale the UL resources provided to the MS based on the residual traffic load or demand. For example, a BS may measure the number of packets or average bit rate for traffic transmitted to or from a MS while in residual traffic state 230. The BS may then adjust or adapt one or more parameters (e.g., bandwidth, data rate, grant size (e.g., in bits), grant interval, or other parameter) of the UL data service (e.g., ertPS or UGS) provided to the MS to match the average (or alternatively match the minimum or maximum) residual traffic data rate associated with the MS (while in the residual traffic state), for example. In other embodiments, the MS may request an increase (or decrease) in the UL resources, and the BS may respond by granting additional (or fewer) resources to the MS while in residual traffic state.

In an example embodiment, the BS may scale or adjust the UL resources allocated or granted to the MS by sending the MS a resource adjustment message. This resource adjustment message may be sent by the BS to the MS based on a measured or detected usage of resources, or amount of residual traffic, or based on a change in the MS's usage of the granted resources (e.g., using all the resources, or not using all the granted resources). For example, a BS may increase the grant size and/or decrease a grant interval if more than a threshold bandwidth or resources are used by the MS during residual traffic state, or if the MS continues to request more resources while in residual traffic state. The MS may request additional UL resources by sending to the BS, for example, an in band bandwidth request in an ertPS header, or a dynamic service change (DSC) message for UGS or other message, as examples. Thus, as more residual traffic is detected (or more resources are used or requested by the MS), the BS may increase the grant size and decrease the grant interval to meet this increased demand. For example, if the MS is using all (or a threshold) of the UL resources provided by the BS, then the BS may increase these resources. Also, the MS may request additional resources, e.g., by using the Bandwidth Request field in MAC (medium access control) header. Likewise, the BS may decrease the resources as the residual traffic or demand for resources during residual traffic state decreases.

In addition, the BS may detect an active traffic pattern associated with the MS, and then may transition the MS from residual traffic state to active state. The active traffic pattern may be indicated based on, for example, a volume of traffic transmitted to or from the MS, or based on the type of traffic transmitted to or from the MS, or an increase in resource requests from the MS (e.g., that exceeds a threshold). For example, an active traffic pattern may be indicated if the amount of traffic to and/or from the MS over a period of time is greater than a threshold, or an amount of resource requests (or requested resources) from the MS exceeds a threshold. Or, an active traffic pattern may be indicated by determining that the type of traffic to or from the MS indicates an active traffic pattern. For example, an active traffic pattern may be indicated by the BS detecting the presence of traffic (e.g., packets) from user applications that are running on the MS, such as downloading web pages via a web browser, transmission or receipt of voice over IP (VoIP) packets, etc. These are merely some examples of an active traffic pattern and the disclosure is not limited thereto.

In response to detecting an active traffic pattern, the BS may transition the MS back to an active state, so that the MS may better handle the increased traffic load. For example, as part of transitioning the MS back to active state, the BS may no longer buffer data directed to the MS (e.g., until threshold amount of data is buffered or timer expires), but may simply forward data to the MS as it is received (with temporary buffering as required). Also, the BS may send the MS a change UL data service message to change the UL data service. In an example embodiment, in response to detecting an active traffic pattern, the BS may change the UL data service back to a service that may better accommodate a heavier data flow, but may be less power efficient, such as a Best Effort (BE) service, or other service that may provide solicited resource grants (e.g., resources provided in response to a request from the MS), for example.

The following list provides some example situations, that may cause a transition between active state and residual traffic state (e.g., which may indicate either an active traffic pattern or a residual traffic pattern):

1) DL data (directed to MS) in BS buffer exceeds a threshold N times over a certain period of time. This may indicate an active traffic pattern;

2) DL data (directed to MS) in BS buffer is less than a lower threshold over a certain period of time. This may indicate a residual traffic pattern;

3) DL data (directed to MS) in BS buffer with residual resources granted to MS would result in latency that exceeds a threshold (e.g., >100 ms). This may indicate an active traffic pattern;

4) More than X % (e.g., more than 90%) of the resources granted to MS in residual traffic state are used by MS over a period of time. This may indicate an active traffic pattern;

5) DL data flow from BS to MS that exceeds a threshold, or by BS detecting traffic to or from MS of a type that is associated with active user applications. This may indicate an active traffic pattern.

6) Amount of DL traffic to MS or UL traffic from MS over a period of time is less than a threshold. This may indicate a residual traffic pattern.

7) MS buffer state is relatively full (MS buffer exceeds a threshold, may indicate active traffic pattern), or relatively empty (MS buffer is less than a threshold may indicate residual traffic pattern).

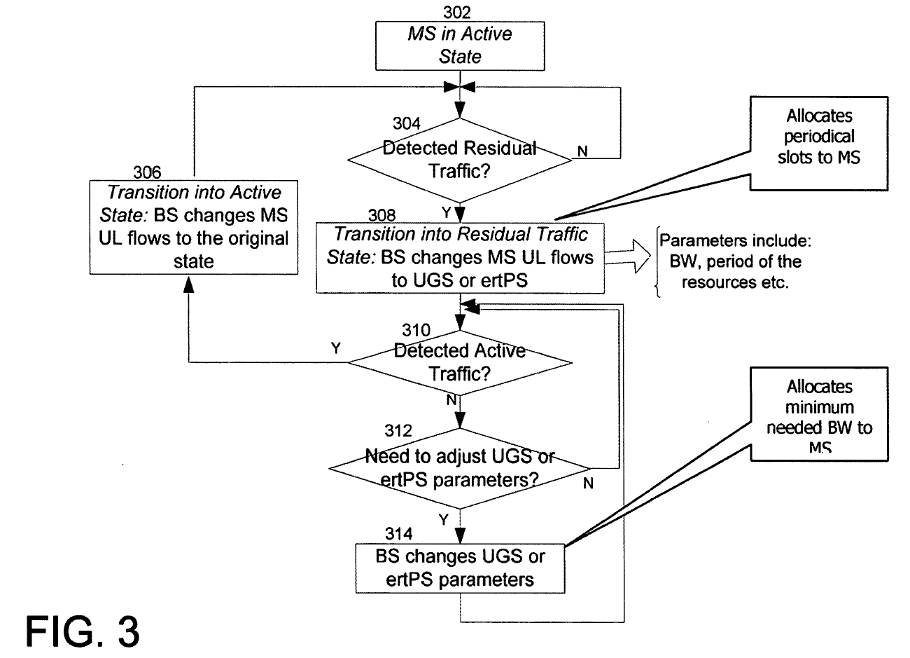

FIG. 3 is a flow chart illustrating operation of a BS or other infrastructure node according to an example embodiment. At 302, the MS is in an active state. At 304, the BS determines if a residual traffic pattern is present or detected (or primarily residual traffic is detected). If a residual traffic pattern is not present or detected, then the flow returns to operation 304.

If a residual traffic pattern is detected or present at 304, the BS transitions the MS to a residual traffic state at 308. Operation 308 may include the BS changing the UL data service type for the MS to a more power efficient service type (e.g., which may use unsolicited resource grants). This may include changing the UL service state for the MS to UGS or ertPS, as examples. The BS may also adjust one or more parameters associated with this new UL data service type, e.g., by scaling the granted UL resources to the residual traffic or residual traffic demand.

At 310, the BS determines whether an active traffic pattern is present. If an active traffic pattern is not present, then at 312 the BS determines whether service parameters need to be adjusted, and if so, these parameters may be adjusted at 314, where the bandwidth, grant interval, data rate, grant size, or other service parameter(s), for example, may be adjusted by the BS to scale the UL resource to the residual traffic or residual traffic demand. The flow then proceeds back to 310.

If at 310, an active traffic pattern is detected, then the BS transitions the MS to active state at 306, e.g., by changing the MS UL data service type back to the original state, e.g., Best Effort or other service type that may typically be used for active state. Flow then proceeds back to 304.

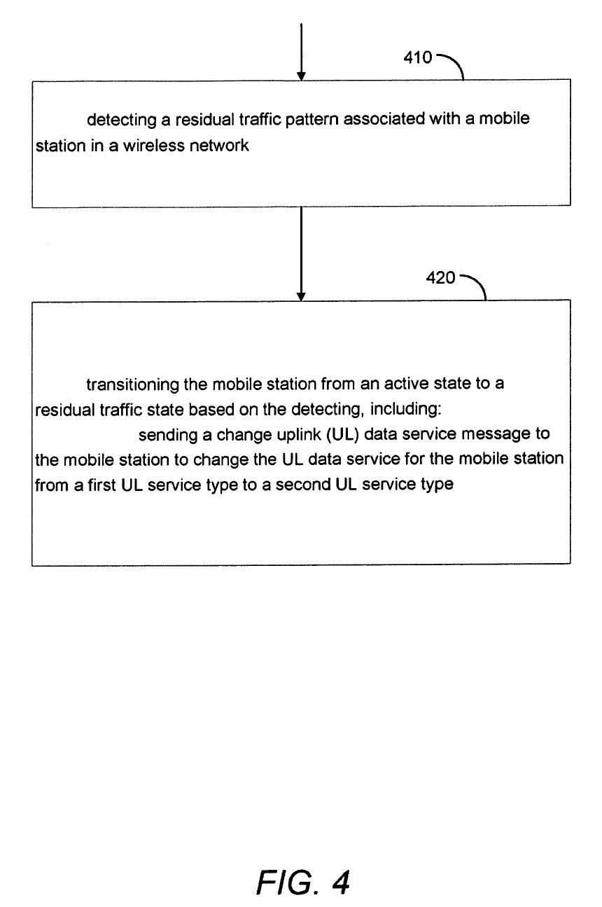

FIG. 4 is a flow chart illustrating operation of a base station or other node according to an example embodiment. Operation 410 may include detecting a residual traffic pattern associated with a mobile station in a wireless network. Operation 420 may include transitioning the mobile station from an active state to a residual traffic state based on the detecting, including: sending a change uplink (UL) data service message to the mobile station to change the UL data service for the mobile station from a first UL service type to a second UL service type.

In an example embodiment, operation 410 may include detecting only residual traffic to or from the mobile station. In an example embodiment, operation 410 may include detecting an amount of traffic to or from the mobile station is less than a threshold amount over a period of time, or detecting an amount of traffic transmitted from the mobile station is less than a threshold amount over a period of time, or detecting an amount of traffic transmitted to the mobile station is less than a threshold amount over a period of time, or detecting an amount of traffic directed to the mobile station that is stored in buffers at base station that is less than a threshold. In an example embodiment, the second UL service type may provide unsolicited UL resource grants to the mobile station at periodic intervals, and the first UL service type may provide resource grants to the mobile station upon solicitation or request from the mobile station.

In an example embodiment, the sending a change uplink (UL) data service message to the mobile station of operation 420 may include sending a change uplink (UL) data service message to the mobile station to change the UL data service for the mobile station from a first UL service type to a second UL service type, the second service type including a data service where a base station provides unsolicited resource grants to the mobile station at periodic intervals.

In an example embodiment, the second UL service type may provide at least one of 1) unsolicited fixed size resource grants at periodic intervals, or 2) unsolicited dynamic size resource grants at periodic intervals where the size of the dynamic size resource grant may be adjusted based on a resource change request from the mobile station.

In an example embodiment, the first UL service type may include a Best Effort service type, and the second UL service type may include one of an extended real time polling service (Extended rtPS) or an uplink grant service (UGS).

In an example embodiment, the transitioning (operation 420) may further include buffering at least some downlink (DL) data directed to the mobile station until an amount of buffered data reaches a threshold or a time limit is reached.

The flow chart of FIG. 4 may further include measuring an amount of residual traffic associated with the mobile station, and adjusting one or more parameters (e.g., a bit or data rate, resource grant size, or period/interval between resource grants) associated with the UL data service for the mobile station at least while the mobile station is in the residual traffic state.

The flow chart of FIG. 4 may further include detecting an active traffic pattern associated with the mobile station, transitioning the mobile station from the residual traffic state to the active state based on the detecting the active traffic pattern, including: sending a change uplink (UL) data service message to the mobile station to change the UL data service for the mobile station from the second UL service type to the first UL service type. In an example embodiment, the detecting an active traffic pattern associated with the mobile station may include detecting an amount of traffic to or from the mobile station over a period of time is greater than a threshold amount. Or, the detecting an active traffic pattern associated with the mobile station may include detecting an amount of active traffic to or from the mobile station over a period of time is greater than a threshold amount.

In an example embodiment, an apparatus may include a controller, a memory coupled to the controller, and a wireless transceiver coupled to the controller. The apparatus may be configured to detect a residual traffic pattern associated with a mobile station in a wireless network, and transition the mobile station from an active state to a residual traffic state based on the detected residual traffic pattern. The transitioning may include sending a change uplink (UL) data service message to the mobile station to change the UL data service for the mobile station from a first UL service type to a second UL service type. The apparatus may be (or may be provided within) a base station or access point, a network controller, a gateway, or other infrastructure node.

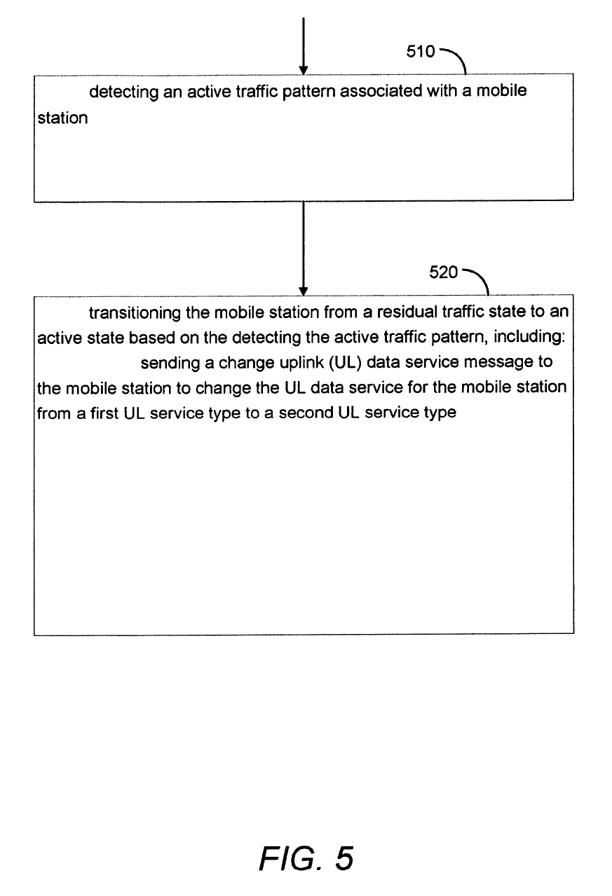

FIG. 5 is a flow chart illustrating operation of a base station or other node according to an example embodiment. Operation 510 may include detecting an active traffic pattern associated with a mobile station. Operation 520 may include transitioning the mobile station from a residual traffic state to an active state based on the detecting the active traffic pattern, including: sending a change uplink (UL) data service message to the mobile station to change the UL data service for the mobile station from a first UL service type to a second UL service type.

In an example embodiment, the sending of operation 520 may include sending a change uplink (UL) data service message to the mobile station to change the UL data service for the mobile station from a first UL service type to a second UL service type, the first UL service type providing unsolicited UL resource grants to the mobile station at periodic intervals, and the second UL service type providing resource grants to the mobile station upon solicitation or request from the mobile station.

In an example embodiment, the second UL service type of the flowchart of FIG. 5 may include a Best Effort service type, and the first UL service type includes one of an extended real time polling service (Extended rtPS) or an uplink grant service (UGS).

In an example embodiment, operation 510 may include detecting an amount of traffic to or from the mobile station over a period of time is greater than a threshold amount, or detecting an amount of active traffic to or from the mobile station over a period of time is greater than a threshold amount.

In another example embodiment, an apparatus may be provided. The apparatus may include a controller, a memory and a wireless transceiver. The apparatus may be configured to detect an active traffic pattern associated with a mobile station, transitioning the mobile station from a residual traffic state to an active state based on the detecting the active traffic pattern, including: sending a change uplink (UL) data service message to the mobile station to change the UL data service for the mobile station from a first UL service type to a second UL service type. In an example embodiment, the apparatus may be (or may be provided within) a base station, access point, a network controller or gateway, or other infrastructure node.

In an example embodiment, network controller 112 or gateway may control or coordinate a number of functions or tasks described above. For example, network controller 112 may detect a residual traffic pattern and transition the MS to residual traffic state, update UL service parameters, detect an active traffic state, and transition the MS back to active state, for example. These measurements by network controller 112 may be based on data provided by the BS, or by the network controller receiving the wireless communications between BS and MS, for example.

According to another example embodiment, a mobile station may participate in a detection of a residual traffic pattern, state transitioning (e.g., transitioning to a residual traffic state), and adaptation of parameters (e.g., data rate, resource grant size, period or interval between resource grants) for an UL data service based on changing traffic load.

In an example embodiment, the mobile station may measure its traffic load (e.g., traffic to or from the MS), an amount of data waiting in the MS's buffers for transmission, or other parameters that may indicate a residual traffic pattern or an active traffic pattern for the MS. The MS may detect a residual traffic pattern, and then send a state transition request to an infrastructure node (e.g., to a BS or network controller, gateway or other node). The infrastructure node may, for example, also measure traffic load to or from the MS, and may confirm that transitioning the MS to a residual traffic state would be appropriate. For example, a BS may make this decision (whether to transition the MS to residual traffic state) or may forward the state transition request to a gateway or network controller which would make this decision to transition the MS to a residual traffic state. The infrastructure node may then send a reply message confirming or instructing the MS to transition to a residual traffic state. This reply may be or may include, for example, a change uplink data service message instructing the MS to change UL data service from a first UL service type to a second UL service type. The infrastructure node (for example, a BS) may buffer data or packets directed to the MS while the MS is in a residual traffic state, and the MS may also buffer data to be transmitted while it is in a residual traffic state.

Likewise, when traffic load increases for the MS, the MS may continue to measure traffic load, and continue to measure the amount of buffered data in its buffers awaiting transmission. When the amount of traffic load or amount of buffered traffic increases or decreases, the MS may send a request to the infrastructure node to or adjust (e.g., either increase or decrease) one or more parameters associated with the UL data service, or other communication parameters, e.g., to accommodate the changed traffic load at the MS.

At some point, the MS may detect an active traffic pattern (e.g., where the amount of traffic to or from the MS and/or an amount of data in buffers awaiting transmission by the MS exceeds a threshold, or other active traffic pattern). In such case, the MS may send the infrastructure node a state transition request to request a transition back to active state for the MS. The infrastructure node may, for example, after confirming that such transition would be appropriate, may send a reply message confirming or instructing the MS to transition back to active state. In such case, the infrastructure node may send a change UL data service message instructing the MS to switch back to the first service type that may typically be used in an active state.

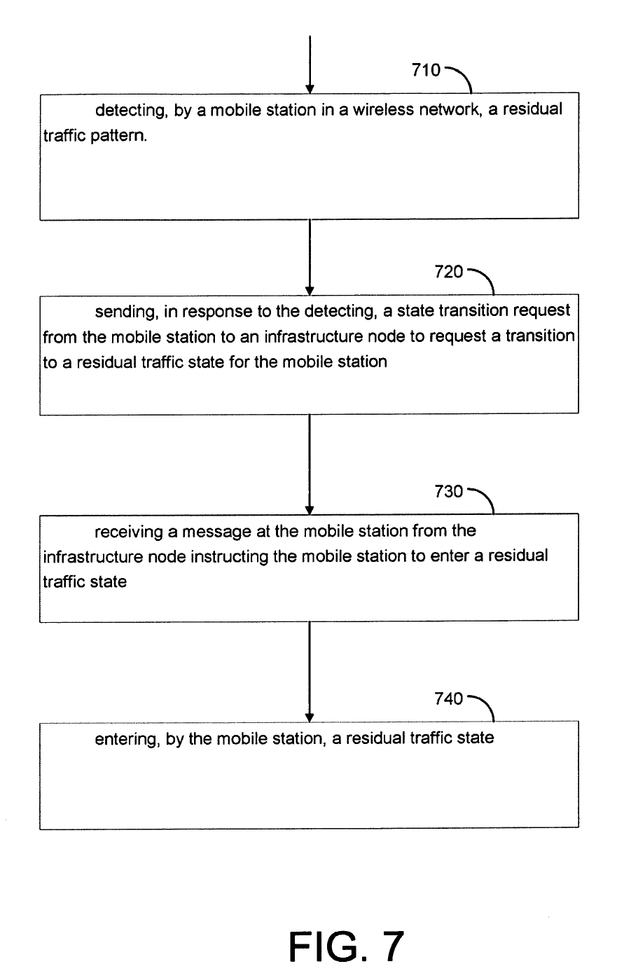

FIG. 7 is a flow chart illustrating operation of a wireless node, such as a mobile station according to an example embodiment. The method may include detecting (710), by a mobile station in a wireless network, a residual traffic pattern, sending (720), in response to the detecting, a state transition request from the mobile station to an infrastructure node to request a transition to a residual traffic state for the mobile station. The method may also include receiving (730) a message at the mobile station from the infrastructure node instructing the mobile station to enter a residual traffic state, and entering (740), by the mobile station, a residual traffic state.

For example, the detecting (710) may include detecting, by a mobile station, a residual traffic pattern associated with a mobile station in a wireless network comprises detecting an amount of traffic transmitted from or received by the mobile station is less than a threshold amount over a period of time. Also, the receiving (730) a message may include receiving a change uplink (UL) data service message to the mobile station to change the UL data service for the mobile station from a first UL service type to a second UL service type.

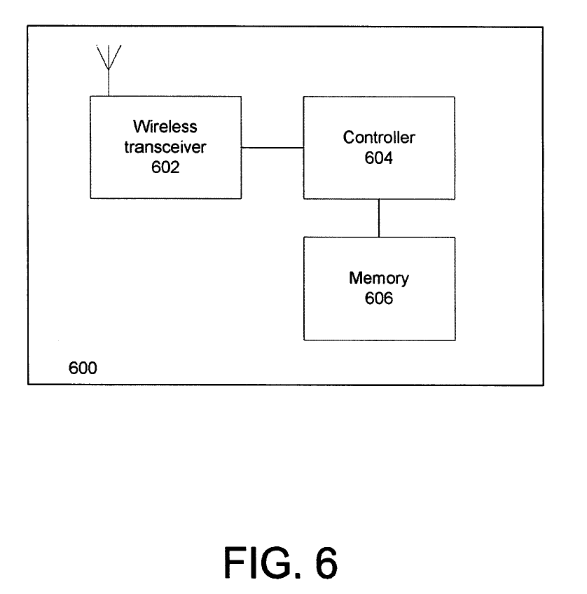

FIG. 6 is a block diagram of a wireless node according to an example embodiment. The wireless node 600 may include a wireless transceiver 602, and a controller 604, and a memory 606. For example, some operations illustrated and/or described herein, may be performed by a controller 604, under control of software or firmware.

In addition, a storage medium may be provided that includes stored instructions, which when executed by a controller or processor may result in a controller, or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
detecting a residual traffic pattern associated with a mobile station in a wireless network; and
transitioning the mobile station from an active state to a residual traffic state based on the detecting, including:
sending a change uplink (UL) data service message to the mobile station to change the UL data service for the mobile station from a first UL service type to a second UL service type.

2. The method of claim 1 wherein the detecting a residual traffic pattern associated with a mobile station in a wireless network comprises detecting only residual traffic to or from the mobile station.

3. The method of claim 1 wherein the detecting a residual traffic pattern associated with a mobile station in a wireless network comprises detecting an amount of traffic to or from the mobile station is less than a threshold amount over a period of time.

4. The method of claim 1 wherein the detecting a residual traffic pattern associated with a mobile station in a wireless network comprises detecting an amount of traffic transmitted from the mobile station is less than a threshold amount over a period of time.

5. The method of claim 1 wherein the detecting a residual traffic pattern associated with a mobile station in a wireless network comprises detecting an amount of traffic transmitted to the mobile station is less than a threshold amount over a period of time.

6. The method of claim 1 wherein the detecting a residual traffic pattern associated with a mobile station in a wireless network comprises detecting an amount of traffic directed to the mobile station that is stored in buffers at an access point is less than a threshold.

7. The method of claim 1 wherein the second UL service type providing unsolicited UL resource grants to the mobile station at periodic intervals, and the first UL service type providing resource grants to the mobile station upon solicitation or request from the mobile station.

8. The method of claim 1 wherein the sending a change uplink (UL) data service message to the mobile station comprises sending a change uplink (UL) data service message to the mobile station to change the UL data service for the mobile station from a first UL service type to a second UL service type, the second service type including a data service where a base station provides unsolicited resource grants to the mobile station at periodic intervals.

9. The method of claim 1 wherein the second UL service type provides at least one of 1) unsolicited fixed size resource grants at periodic intervals, or 2) unsolicited dynamic size resource grants at periodic intervals where the size of the dynamic size resource grant may be adjusted based on a resource change request from the mobile station.

10. The method of claim 1 wherein the first UL service type includes a Best Effort service type, and the second UL service type includes one of an extended real time polling service (Extended rtPS) or an uplink grant service (UGS).

11. The method of claim 1 wherein the transitioning further includes buffering at least some downlink (DL) data directed to the mobile station until an amount of buffered data reaches a threshold or a time limit is reached.

12. The method of claim 1 and further comprising:
measuring an amount of residual traffic associated with the mobile station; and
adjusting one or more parameters associated with the UL data service for the mobile station at least while the mobile station is in the residual traffic state.

13. The method of claim 12 wherein the adjusting one or more parameters comprises adjusting one or more of a bit or data rate, resource grant size, or period between resource grants for the mobile station.

14. The method of claim 1 and further comprising:
detecting an active traffic pattern associated with the mobile station;
transitioning the mobile station from the residual traffic state to the active state based on the detecting the active traffic pattern, including:
sending a change uplink (UL) data service message to the mobile station to change the UL data service for the mobile station from the second UL service type to the first UL service type.

15. The method of claim 14 wherein the detecting an active traffic pattern associated with the mobile station comprises detecting an amount of traffic to or from the mobile station over a period of time is greater than a threshold amount.

16. The method of claim 14 wherein the detecting an active traffic pattern associated with the mobile station comprises detecting an amount of active traffic to or from the mobile station over a period of time is greater than a threshold amount.

17. An apparatus comprising:
a controller;
a memory coupled to the controller; and
a wireless transceiver coupled to the controller;
the apparatus being configured to:
detect a residual traffic pattern associated with a mobile station in a wireless network; and
transition the mobile station from an active state to a residual traffic state based on the detected residual traffic pattern, including:
send a change uplink (UL) data service message to the mobile station to change the UL data service for the mobile station from a first UL service type to a second UL service type.

18. The apparatus of claim 17 wherein the apparatus comprises a base station.

19. A method comprising:
detecting an active traffic pattern associated with a mobile station;
transitioning the mobile station from a residual traffic state to an active state based on the detecting the active traffic pattern, including:
sending a change uplink (UL) data service message to the mobile station to change the UL data service for the mobile station from a first UL service type to a second UL service type.

20. The method of claim 19 wherein the sending a change uplink (UL) data service message comprises sending a change uplink (UL) data service message to the mobile station to change the UL data service for the mobile station from a first UL service type to a second UL service type, the first UL service type providing unsolicited UL resource grants to the mobile station at periodic intervals, and the second UL service type providing resource grants to the mobile station upon solicitation or request from the mobile station.

21. The method of claim 19 wherein the second UL service type includes a Best Effort service type, and the first UL service type includes one of an extended real time polling service (Extended rtPS) or an uplink grant service (UGS).

22. An apparatus provided at a first physical access point (AP) in a wireless network comprising:
a controller;
a memory coupled to the controller; and
a wireless transceiver coupled to the controller;
the apparatus being configured to:
detect an active traffic pattern associated with a mobile station;
transition the mobile station from a residual traffic state to an active state based on the detected active traffic pattern, including:
send a change uplink (UL) data service message to the mobile station to change the UL data service for the mobile station from a first UL service type to a second UL service type, the first UL service type providing unsolicited UL resource grants to the mobile station at periodic intervals, and the second UL service type providing resource grants to the mobile station upon solicitation or request from the mobile station.

23. A method comprising:
detecting, by a mobile station in a wireless network, a residual traffic pattern;
sending, in response to the detecting, a state transition request from the mobile station to an infrastructure node to request a transition to a residual traffic state for the mobile station;
receiving a message at the mobile station from the infrastructure node instructing the mobile station to enter a residual traffic state; and
entering, by the mobile station, a residual traffic state.

24. The method of claim 23 wherein the detecting comprises detecting, by a mobile station, a residual traffic pattern associated with a mobile station in a wireless network comprises detecting an amount of traffic transmitted from or received by the mobile station is less than a threshold amount over a period of time.

25. The method of claim 23 wherein the receiving a message comprises receiving a change uplink (UL) data service message to the mobile station to change the UL data service for the mobile station from a first UL service type to a second UL service type.
